(19) United States
(12) Patent Application Publication
(10) Pub. No.: US 2014/0263452 A1
(43) Pub. Date: Sep. 18, 2014

(54) MELTING SYSTEM

(71) Applicant: GRACO MINNESOTA INC., Minneapolis, MN (US)

(72) Inventors: Michael J. Sebion, Apple Valley, MN (US); Nicholas D. Long, Broadview Heights, OH (US); Shaun M. Cook, Tampla, FL (US); Mark W. Sheahan, Inver Grover Heights, MN (US); Mark T. Weinberger, Mounds View, MN (US); Mark J. Brudevold, Fridley, MN (US); Joseph E. Tix, Hastings, MN (US); John S. Lihwa, Willowick, OH (US); Douglas B. Farrow, Plymouth, MN (US); Robert J. Lind, Robbinsdale, MN (US); Paul R. Quam, Brooklyn Center, MN (US); Daniel P. Ross, Maplewood, MN (US)

(73) Assignee: GRACO MINNESOTA INC., Minneapolis, MN (US)

(21) Appl. No.: 13/800,520

(22) Filed: Mar. 13, 2013

(51) Int. Cl. B67D 7/80

(52) U.S. Cl. CPC B05B 9/002
USPC 222/146.5

(57) ABSTRACT

A melting system includes a hopper for receiving solid hot melt material, a heated conduit in communication with the hopper for melting the solid hot melt material, and a valve for allowing solid hot melt material to flow from the hopper to the heated conduit. The valve includes a disk movable between a closed position and an open position, a stem connected to the disk and an actuator for controlling the position of the disk. The disk prevents solid hot melt material from flowing from the hopper to the conduit in the closed position and allows solid hot melt material to flow from the hopper to the conduit in the open position.

### BACKGROUND

The present disclosure relates generally to systems for dispensing hot melt adhesive. More particularly, the present disclosure relates to a melting system for preparing liquid hot melt adhesive.

Hot melt dispensing systems are typically used in manufacturing assembly lines to automatically disperse an adhesive used in the construction of packaging materials such as boxes, cartons and the like. Hot melt dispensing systems conventionally comprise a material tank, heating elements, a pump and a dispenser. Solid polymer pellets are melted in the tank using a heating element before being supplied to the dispenser by the pump. Because the melted pellets will re-solidify into solid form if permitted to cool, the melted pellets must be maintained at temperature from the tank to the dispenser. This typically requires placement of heating elements in the tank, the pump and the dispenser, as well as heating any tubing or hoses that connect those components. Furthermore, conventional hot melt dispensing systems typically utilize tanks having large volumes so that extended periods of dispensing can occur after the pellets contained therein are melted. However, the large volume of pellets within the tank requires a lengthy period of time to completely melt, which increases start-up times for the system. For example, a typical tank includes a plurality of heating elements lining the walls of a rectangular, gravity-fed tank such that melted pellets along the walls prevents the heating elements from efficiently melting pellets in the center of the container. The extended time required to melt the pellets in these tanks increases the likelihood of “charring” or darkening of the adhesive due to prolonged heat exposure.

### SUMMARY

A melting system includes a hopper for receiving solid hot melt material, a heated conduit in communication with the hopper for melting the solid hot melt material, and a valve for allowing solid hot melt material to flow from the hopper to the heated conduit. The valve includes a disk movable between a closed position and an open position, a stem connected to the disk and an actuator for controlling the position of the disk. The disk prevents solid hot melt material from flowing from the hopper to the conduit in the closed position and allows solid hot melt material to flow from the hopper to the conduit in the open position.

A hot melt dispensing system includes a container for storing solid hot melt material, a hopper for receiving solid hot melt material, a feed system for transporting solid hot melt material from the container to the hopper, a heated conduit in communication with the hopper for melting the solid hot melt material, a valve for allowing solid hot melt material to flow from the hopper to the heated conduit and a dispensing system for administering the liquefied hot melt material. The valve includes a disk movable between a closed position and an open position, a stem connected to the disk and an actuator for controlling the position of the disk. The disk prevents solid hot melt material from flowing from the hopper to the conduit in the closed position and allows solid hot melt material to flow from the hopper to the conduit in the open position.

A method for melting a solid hot melt material includes delivering the solid adhesive material to a vessel having a valve system. The valve system includes a disk movable between a closed position and an open position, a stem connected to the disk and an actuator for controlling the position of the disk. The disk prevents solid hot melt material from flowing from the hopper to the conduit in the closed position and allows solid hot melt material to flow from the hopper to the conduit in the open position. The method further includes positioning the disk of the valve system in the open position to allow a portion of the solid hot melt material in the vessel to flow into a connected conduit, positioning the disk of the valve system in the closed position to prevent additional solid hot melt material from flowing from the vessel to the conduit, heating the conduit to liquefy the solid hot melt material located therein, delivering the liquefied hot melt material to a dispensing system and administering the liquefied hot melt material.

### BRIEF DESCRIPTION OF THE DRAWINGS

FIG. 1 is a schematic view of a system for dispensing hot melt adhesive.

FIG. 2 is a view of one embodiment of the melt system within the system of FIG. 1 in a closed position.

FIG. 3 is a view of the melt system of FIG. 2 in an open position.

### DETAILED DESCRIPTION

Conventional hot melt dispensing systems do not typically have short startup times. The system components generally need to be “warmed up” (heated to reach operating temperatures) before dispensing can commence. Additionally, the solid hot melt material to be dispensed must be heated to form a liquid so that it can flow through the system and be dispensed. In most systems, the solid hot melt material is added to a melting vessel, often as a large solid mass. In these systems, melting the solid hot melt material takes significant time. The invention described herein provides a melting system that can quickly liquefy hot melt material.

FIG. 1 is a schematic view of system 10, which is a system for dispensing hot melt adhesive. System 10 includes cold section 12, hot section 14, air source 16, air control valve 17, and controller 18. In the embodiment shown in FIG. 1, cold section 12 includes container 20 and feed assembly 22, which includes vacuum assembly 24, feed hose 26, and inlet 28. In the embodiment shown in FIG. 1, hot section 14 includes melt system 30, pump 32, and dispenser 34. Air source 16 is a source of compressed air supplied to components of system 10 in both cold section 12 and hot section 14. Air control valve 17 is connected to air source 16 via air hose 35A, and selectively controls air flow from air source 16 through air hose 35B to vacuum assembly 24 and through air hose 35C to motor 36 of pump 32. Air hose 35D connects air source 16 to dispenser 34, bypassing air control valve 17. Controller 18 is connected in communication with various components of system 10, such as air control valve 17, melt system 30, pump 32, and/or dispenser 34, for controlling operation of system 10.

Components of cold section 12 can be operated at room temperature, without being heated. Container 20 can be a hopper for containing a quantity of solid adhesive pellets (solid hot melt material) for use by system 10. Suitable adhesives can include, for example, a thermoplastic polymer glue such as ethylene vinyl acetate (EVA) or metallocene-based hot melt adhesives. Feed assembly 22 connects container 20 to hot section 14 for delivering the solid adhesive pellets from container 20 to hot section 14. Feed assembly 22 includes vacuum assembly 24 and feed hose 26. Vacuum assembly 24 is positioned in container 20. Compressed air from air source 16 and air control valve 17 is delivered to vacuum assembly 24 to create a vacuum, inducing flow of solid adhesive pellets into inlet 28 of vacuum assembly 24 and then through feed hose 26 to hot section 14. Feed hose 26 is a tube or other passage sized with a diameter substantially larger than that of the solid adhesive pellets to allow the solid adhesive pellets to flow freely through feed hose 26. Feed hose 26 connects vacuum assembly 24 to hot section 14.

Solid adhesive pellets are delivered from feed hose 26 to melt system 30. Melt system 30 can include a vessel (conduit 48, shown in FIG. 2) and resistive heating elements (not shown) for melting the solid adhesive pellets to form a hot melt adhesive in liquid form (liquefied hot melt material). Melt system 30 can be sized to have a relatively small adhesive volume, for example about 0.5 liters, and configured to melt solid adhesive pellets in a relatively short period of time. Pump 32 is driven by motor 36 to pump hot melt adhesive from melt system 30 to dispenser 34 through supply hose 38. Motor 36 can be an air motor driven by pulses of compressed air from air source 16 and air control valve 17. Pump 32 can be a linear displacement pump driven by motor 36. In the illustrated embodiment, dispenser 34 includes manifold 40 and module 42. Hot melt adhesive from pump 32 is received in manifold 40 and dispensed via module 42. Dispenser 34 can selectively discharge hot melt adhesive whereby the hot melt adhesive is sprayed out outlet 44 of module 42 onto an object, such as a package, a case, or another object benefiting from hot melt adhesive dispensed by system 10. Module 42 can be one of multiple modules that are part of dispenser 34. In an alternative embodiment, dispenser 34 can have a different configuration, such as a handheld gun-type dispenser. Some or all of the components in hot section 14, including melt system 30, pump 32, supply hose 38, and dispenser 34, can be heated to keep the hot melt adhesive in a liquid state throughout hot section 14 during the dispensing process.

System 10 can be part of an industrial process, for example, for packaging and sealing cardboard packages and/or cases of packages. In alternative embodiments, system 10 can be modified as necessary for a particular industrial process application. For example, in one embodiment (not shown), pump 32 can be separated from melt system 30 and instead attached to dispenser 34. Supply hose 38 can then connect melt system 30 to pump 32.

FIGS. 2 and 3 illustrate a view of one embodiment of melt system 30. Melt system 30 includes hopper 46, conduit 48 and valve 50. Hopper receives solid adhesive pellets (represented by reference numeral 31) from feed hose 26 before they are allowed to flow to conduit 48. Hopper receives the solid adhesive pellets through inlet portion 52. Inlet portion 52 is located in an upper portion of hopper 46 as shown in FIG. 2. Outlet portion 54 is located generally opposite of inlet portion 52. Gravity causes solid adhesive pellets introduced into hopper 46 at inlet portion 52 to flow towards outlet portion 54.

Outlet portion 54 of hopper 46 is connected to conduit 48. Conduit 48 is a vessel or pipe located between hopper 46 and pump 32. Conduit 48 is heated so that solid adhesive pellets that flow into conduit 48 melt to form liquid adhesive (represented by reference numeral 33). As shown in FIGS. 2 and 3, conduit 48 contains an amount of liquid adhesive, made up of solid adhesive pellets that have melted. A minimum amount of liquid adhesive is maintained within conduit 48. As solid adhesive pellets from hopper 46 enter conduit 48, the liquid adhesive present within conduit 48 transfers heat to the solid adhesive pellets, causing the solid adhesive pellets to melt and become additional liquid adhesive.

Maintaining a minimum amount of liquid adhesive within conduit 48 ensures that heat is rapidly transferred to newly entering solid adhesive pellets. Heat is transferred from the liquid adhesive to substantially all of the surface area of the solid adhesive pellets, instead of just the surfaces of the solid adhesive pellets that contact a heating element or hot surface. In some embodiments, conduit 48 has a relatively small volume to minimize the amount of heat energy needed to maintain the melted adhesive in a liquid state and melt incoming solid adhesive pellets. The volume of conduit 48 can be sized so that it contains sufficient volume to continuously supply pump 32 with liquid adhesive for a predetermined period of time or a predetermined number of pump cycles.

Conduit 48 is heated by one or more heating elements. Heating elements can be positioned within the walls of conduit 48 or around the outer walls of conduit 48. In some embodiments, one or more resistive heating elements are used to heat conduit 48 and its contents. Heating element 56 is shown in FIG. 2 within the walls of conduit 48.

In some embodiments, conduit 48 includes a turn. FIGS. 2 and 3 illustrate conduit 48 having turn 58. First portion 60 of conduit 48 is oriented to have a vertical longitudinal axis while second portion 62 is oriented to have a non-vertical longitudinal axis.

Valve 50 is located within hopper 46 or conduit 48 or between hopper 46 and conduit 48 and controls the flow of solid adhesive pellets from hopper 46 to conduit 48. Valve 50 includes disk 64, stem 66 and actuator 68. Disk 64 is a plate through which solid adhesive pellets cannot pass. In some embodiments, disk 64 is a solid circular plate. Stem 66 connects disk 64 and actuator 68. In embodiments in which conduit 48 includes turn 58, stem 66 can pass through the wall of conduit 48 before connecting to actuator 68 as shown in FIGS. 2 and 3. Actuator 68 is a motor or other device capable of producing movement that is translated from stem 66 to disk 64. Disk 64 is moveable between open and closed positions allowing valve 50 to allow and prevent the flow of solid adhesive pellets from hopper 46 to conduit 48.

As shown in FIG. 2, when valve 50 is in the closed position, disk 64 is located between the solid adhesive pellets within hopper 46 and the liquid adhesive within conduit 48. In some embodiments, valve 50 also includes seat 70. Disk 64 rests on seat 70 in the closed position, forming a seal that both prevents solid adhesive pellets from entering conduit 48 and minimizes convective heat transfer from air within conduit 48 to hopper 46, thereby eliminating and/or inhibiting premature melting of the solid adhesive pellets within hopper 46. In the closed position, valve 50 prevents the flow of solid adhesive pellets from hopper 46 to conduit 48.

Disk 64 is moved in a direction away from conduit 48 in order to transition valve 50 into an open position. Actuator 68 moves stem 66 so that disk 64 travels away from conduit 48. As disk 64 moves away from conduit 48, gravitational force causes solid adhesive pellets within hopper 46 to descend around the edges of disk 64 and to fall into conduit 48 as shown in FIG. 3. As the solid adhesive pellets enter the liquid adhesive in heated conduit 48, the solid adhesive pellets melt to form additional liquid adhesive. Disk 64 can be moved away from conduit 48 to varying degrees to allow the solid adhesive pellets to flow slowly from hopper 46 to conduit 48 (relatively closer to conduit 48) or to flow rapidly (farther from conduit 48). In some embodiments, actuator 68 and stem 66 can also move disk 64 in an up-and-down motion to dislodge solid adhesive pellets that may have partially melted and solidified or congealed to form a larger clump of adhesive near hopper outlet portion 54. In these embodiments, disk 64 pulls adhesive material from hopper 46 into conduit 48.

In some embodiments, actuator 68 and pump 32 are both given instructions by controller 18 (shown in FIG. 1). Controller 18 controls the position of valve 50, the frequency of open and closed positions for valve 50, and pump 32 so that the amount of liquid adhesive present in conduit 48 is maintained at or above the minimum needed to rapidly melt the solid adhesive pellets entering conduit 48 through valve 50. Additionally, controller 18 controls valve 50 and pump 32 so that the amount of solid adhesive pellets flowing into heated conduit 48 provide new liquid adhesive at a rate substantially equivalent to a rate that pump 32 delivers the adhesive to dispenser 34.

By utilizing a heated conduit containing melted (liquid) hot melt material, system 10 does not require a separate melting tank for melting the hot melt material. By utilizing a small, heated conduit rather than a melting tank, system 10 can be started up more quickly, less time is needed to melt the solid adhesive pellets and the amount of power required to melt the pellets is reduced.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A melting system comprising:
a hopper for receiving solid hot melt material;
a heated conduit in communication with the hopper for melting the solid hot melt material; and
a valve for allowing solid hot melt material to flow from the hopper to the heated conduit, the valve comprising:
a disk movable between a closed position and an open position, wherein the disk prevents solid hot melt material from flowing from the hopper to the conduit in the closed position and allows solid hot melt material to flow from the hopper to the conduit in the open position;
a stem connected to the disk; and
an actuator for controlling the position of the disk.

2. The melting system of claim 1, wherein the hopper comprises an inlet and an outlet, and wherein the disk is located between the hopper inlet and the hopper outlet in the open position.

3. The melting system of claim 1, wherein the heated conduit comprises a resistive heating element for heating the conduit.

4. The melting system of claim 1, wherein the heated conduit comprises a turn, and wherein the stem extends through a bottom portion of the turn.

5. The melting system of claim 2, wherein the hopper comprises a seat for receiving the disk when the disk is in the closed position.

6. The melting system of claim 1, wherein the heated conduit comprises a seat for receiving the disk when the disk is in the closed position.

7. A hot melt dispensing system comprising:
a container for storing solid hot melt material;
a hopper for receiving solid hot melt material;
a feed system for transporting solid hot melt material from the container to the hopper;
a heated conduit in communication with the hopper for melting the solid hot melt material;
a valve for allowing solid hot melt material to flow from the hopper to the heated conduit, the valve comprising:
a disk movable between a closed position and an open position, wherein the disk prevents solid hot melt material from flowing from the hopper to the conduit in the closed position and allows solid hot melt material to flow from the hopper to the conduit in the open position;
a stem connected to the disk; and
an actuator for controlling the position of the disk; and
a dispensing system for administering the liquefied hot melt material.

8. The hot melt dispensing system of claim 7, further comprising:
a fluid pump for delivering the liquefied hot melt material from the heated conduit to the dispensing system.

9. The hot melt dispensing system of claim 7, wherein the hopper comprises an inlet and an outlet, and wherein the disk is located between the hopper inlet and the hopper outlet in the open position.

10. The hot melt dispensing system of claim 7, wherein the heated conduit comprises a resistive heating element for heating the conduit.

11. The hot melt dispensing system of claim 7, wherein the heated conduit comprises a turn, and wherein the stem extends through a bottom portion of the turn.

12. The hot melt dispensing system of claim 7, wherein the hopper comprises a seat for receiving the disk when the disk is in the closed position.

13. The hot melt dispensing system of claim 7, wherein the heated conduit comprises a seat for receiving the disk when the disk is in the closed position.

14. The hot melt dispensing system of claim 8, further comprising:
a controller, wherein the controller coordinates the actuator and the fluid pump so that the valve allows solid hot melt material to flow into the heated conduit to provide liquefied hot melt material at a rate substantially equivalent to a rate the fluid pump delivers the liquefied hot melt material to the dispensing system.

15. A method for melting a solid hot melt material, the method comprising:
delivering the solid adhesive material to a vessel having a valve system, the valve system comprising:
a disk movable between a closed position and an open position, wherein the disk prevents solid hot melt material from flowing from the hopper to the conduit in the closed position and allows solid hot melt material to flow from the hopper to the conduit in the open position;
a stem connected to the disk; and
an actuator for controlling the position of the disk; and
positioning the disk of the valve system in the open position to allow a portion of the solid hot melt material in the vessel to flow into a connected conduit;
positioning the disk of the valve system in the closed position to prevent additional solid hot melt material from flowing from the vessel to the conduit;
heating the conduit to liquefy the solid hot melt material located therein;
delivering the liquefied hot melt material to a dispensing system; and
administering the liquefied hot melt material.

16. The method of claim 15, wherein the hopper comprises an inlet and an outlet, and wherein the disk is located between the hopper inlet and the hopper outlet in the open position.

17. The method of claim 15, wherein the portion of the solid hot melt material allowed to flow into the conduit per unit time is substantially equal to an amount of liquefied hot melt material delivered to the dispensing system per unit time.

18. The method of claim 15, wherein the disk pulls solid hot melt material from the hopper into the conduit when it is moved from the open position to the closed position.
